(19) United States
(12) Patent Application Publication
(10) Pub. No.: US 2022/0067615 A1
(43) Pub. Date: Mar. 3, 2022

(54) INFORMATION PROVIDING APPARATUS, VEHICLE, INFORMATION PROVIDING SYSTEM, NON-TRANSITORY COMPUTER READABLE MEDIUM, AND INFORMATION PROVIDING METHOD

(71) Applicant: TOYOTA JIDOSHA KABUSHIKI KAISHA, Toyota-shi Aichi-ken (JP)

(72) Inventors: Tae Sugimura, Miyoshi-shi Aichi-ken (JP); Kenta Miyahara, Toyota-shi Aichi-ken (JP); Ayana Takeshita, Kasugai-shi Aichi-ken (JP); Changyi Luo, Kokubunji-shi Tokyo-to (JP); Yuhei Suzuki, Kariya-shi Aichi-ken (JP)

(73) Assignee: TOYOTA JIDOSHA KABUSHIKI KAISHA, Toyota-shi Aichi-ken (JP)

(21) Appl. No.: 17/460,946

(22) Filed: Aug. 30, 2021

(30) Foreign Application Priority Data
Aug. 31, 2020 (JP) 2020-146260

(51) Int. Cl. G06Q 10/06; G06Q 50/12; G06Q 10/08; B60P 3/025; G01S 19/01

(52) U.S. Cl. CPC G06Q 10/06315; G06Q 50/12; G01S 19/01; G06Q 10/06312; B60P 3/0257; G06Q 10/0875

(57) ABSTRACT

An information providing apparatus includes a controller configured to: estimate whether an ingredient of a first meal to be cooked with the ingredient in a vehicle will be in surplus, in which the first meal was scheduled to be provided to a first user but will not be provided to the first user; and in a case in which it is estimated that the ingredient will be in surplus, determine a site at which to provide a second meal to be cooked with the ingredient in the vehicle, to a second user different from the first user.

### CROSS-REFERENCE TO RELATED APPLICATION

This application claims priority to Japanese Patent Application No. 2020-146260, filed on Aug. 31, 2020, the entire contents of which are incorporated herein by reference.

### TECHNICAL FIELD

The present disclosure relates to an information providing apparatus, a vehicle, an information providing system, an information providing program, and an information providing method.

### BACKGROUND

Patent Document (PTL) 1 describes technology for providing, to an operator of a restaurant, reservation information accepted by an Internet service provider from a user of the restaurant.

### CITATION LIST

### Patent Literature

PTL 1: JP 2002-279261 A

### SUMMARY

According to the technology described in PTL 1, in a case in which a reservation for a restaurant made by a user of the restaurant is cancelled, an ingredient in surplus will go waste.

It would be helpful to effectively use an ingredient in surplus.

An information providing apparatus according to the present disclosure includes a controller configured to:

estimate whether an ingredient of a first meal to be cooked with the ingredient in a vehicle will be in surplus, in which the first meal was scheduled to be provided to a first user but will not be provided to the first user; and

in a case in which it is estimated that the ingredient will be in surplus, determine a site at which to provide a second meal to be cooked with the ingredient in the vehicle, to a second user different from the first user.

An information providing program according to the present disclosure is configured to cause a computer to execute operations, the operations including:

estimating whether an ingredient of a first meal to be cooked with the ingredient in a vehicle will be in surplus, in which the first meal was scheduled to be provided to a first user but will not be provided to the first user; and

in a case in which it is estimated that the ingredient will be in surplus, determining a site at which to provide a second meal to be cooked with the ingredient in the vehicle, to a second user different from the first user.

An information providing method according to the present disclosure includes:

estimating, by an information providing apparatus, whether an ingredient of a first meal to be cooked with the ingredient in a vehicle will be in surplus, in which the first meal was scheduled to be provided to a first user but will not be provided to the first user; and

in a case in which it is estimated that the ingredient will be in surplus, determining, by the information providing apparatus, a site at which to provide a second meal to be cooked with the ingredient in the vehicle, to a second user different from the first user.

The present disclosure enables to effectively use an ingredient in surplus.

### BRIEF DESCRIPTION OF THE DRAWINGS

In the accompanying drawings:

FIG. 1 is a diagram illustrating a configuration of an information providing system according to an embodiment of the present disclosure;

FIG. 2 is a block diagram illustrating a configuration of an information providing apparatus according to an embodiment of the present disclosure;

FIG. 3 is a block diagram illustrating a configuration of a terminal apparatus according to an embodiment of the present disclosure;

FIG. 4 is a block diagram illustrating a configuration of a vehicle according to an embodiment of the present disclosure;

FIG. 5 is a flowchart illustrating operations of an information providing system according to an embodiment of the present disclosure; and

FIG. 6 is a diagram illustrating a screen example of a terminal apparatus according to an embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

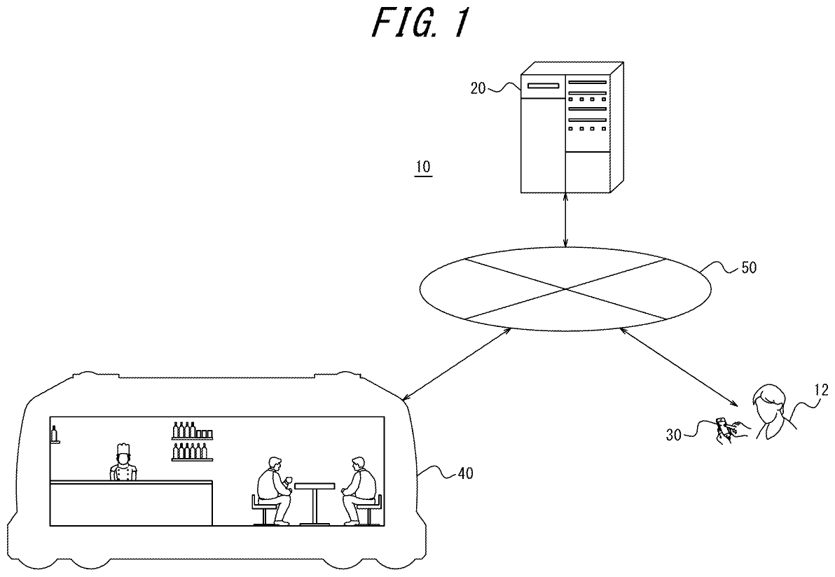

With reference to FIG. 1, a configuration of the information providing system 10 according to the present embodiment will be described.

The information providing system 10 includes an information providing apparatus 20, at least one terminal apparatus 30, and at least one vehicle 40.

The information providing apparatus 20 can communicate with the terminal apparatus 30 and the vehicle 40 via a network 50. The terminal apparatus 30 may also be able to communicate with the vehicle 40 via the network 50.

The network 50 includes the Internet, at least one WAN, at least one MAN, or a combination thereof. The term “WAN” is an abbreviation of wide area network. The term “MAN” is an abbreviation of metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The information providing apparatus 20 is installed in a facility such as a data center. The information providing apparatus 20 is, for example, a server that belongs to a crowd computing system or another computing system.

The terminal apparatus 30 is held by a second user 12. The terminal apparatus 30 is, for example, a mobile apparatus such as a mobile phone, a smartphone, or a tablet, or a PC. The term “PC” is an abbreviation of personal computer.

The vehicle 40 is, for example, any type of automobile such as a gasoline vehicle, a diesel vehicle, a hydrogen vehicle, an HEV, a PEHV, a BEV, or an FCEV. The term “HEV” is an abbreviation of hybrid electric vehicle. The term “PEHV” is an abbreviation of plug-in hybrid electric vehicle. The term “BEV” is an abbreviation of battery electric vehicle. The term “FCEV” is an abbreviation of fuel cell electric vehicle. The vehicle 40, which is an AV in the present embodiment, may be driven by a driver, or the driving may be automated at any level. The term “AV” is an abbreviation for autonomous vehicle. The level of automation is, for example, any of Level 1 to Level 5 according to the classification of the SAE. The name “SAE” is an abbreviation of Society of Automotive Engineers. The vehicle 40 may be a MaaS-dedicated vehicle. The term “MaaS” is an abbreviation of Mobility as a Service.

With reference to FIG. 1, an outline of the present embodiment will be described.

In the present embodiment, the information providing apparatus 20 estimates whether an ingredient of a first meal to be cooked with the ingredient in the vehicle 40 will be in surplus, in which the first meal was scheduled to be provided to a first user but will not be provided to the first user.

In the present embodiment, the vehicle 40 is operated as a restaurant provided with cooking facilities and a dining space. The first user has made a reservation for a meal to be provided at the dining space of the vehicle 40. In the vehicle 40, an ingredient is procured in accordance with the reservation from the first user. That is, when a type of a meal that the first user desires to be provided and a date and time that the first user desires to have the meal provided are designated by the first user upon making the reservation, the vehicle 40 procures an ingredient in accordance with the type of the meal desired by the first user. The procured ingredient will be cooked and provided to the first user on the date and time on which the first user desires to have the meal provided.

In the present embodiment, it is estimated whether an ingredient procured in the vehicle 40 will be in surplus due to that the ingredient, which was scheduled to be provided to the first user, will no longer be provided to the first user. Specifically, it is taken into consideration whether the reservation is likely to be cancelled by the first user. The reason to take into consideration whether the reservation made by the first user is likely to be cancelled is that when the reservation from the first user is cancelled, the meal that was scheduled to be provided to the first user will no longer be needed and the ingredient procured will be in surplus.

In the present embodiment, in a case in which it is estimated that the ingredient will be in surplus, the information providing apparatus 20 determines a site at which to provide a second meal to be cooked with the ingredient in the vehicle 40, to a second user 12 different from the first user. In the present embodiment, the second user 12 is a user who is among users outside the vehicle 40 and other than the first user. The second site is determined in accordance with a provision form in which the second meal is to be provided. That is, in a case in which the second meal is scheduled to be provided at the vehicle 40, a site at which the vehicle 40 is located is determined as the second site. In a case in which the second meal is scheduled to be delivered to the second user 12 by the vehicle 40, a site at which the second meal can be delivered by the vehicle 40 is determined as the second site. The second meal is provided to the second user 12 at the second site determined.

According to the present embodiment, an ingredient that is estimated to be in surplus without being provided to the first user will be provided to the second user 12. As a result, an ingredient in surplus can be effectively utilized without going waste.

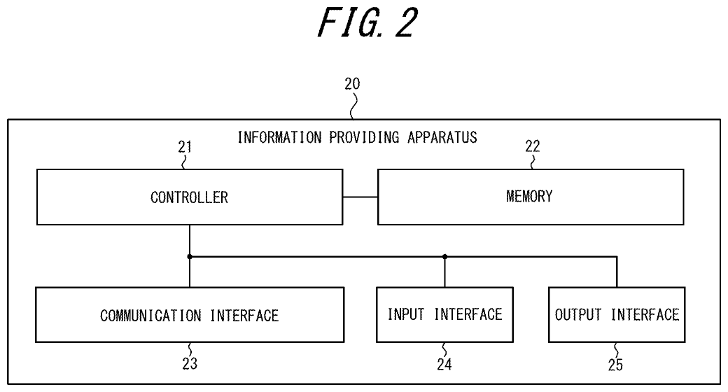

With reference to FIG. 2, a configuration of the information providing apparatus 20 according to the present embodiment will be described.

The information providing apparatus 20 includes a controller 21, a memory 22, a communication interface 23, an input interface 24, and an output interface 25.

The controller 21 includes at least one processor, at least one programmable circuit, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to the operations of the information providing apparatus 20 while controlling components of the information providing apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the information providing apparatus 20 and data obtained by the operations of the information providing apparatus 20.

The communication interface 23 includes at least one interface for communication. The interface for communication is, for example, a LAN interface. The communication interface 23 receives data to be used for the operations of the information providing apparatus 20, and transmits data obtained by the operations of the information providing apparatus 20. In the present embodiment, the communication interface 23 communicates with the terminal apparatus 30. The communication interface 23 also communicates with the vehicle 40.

The input interface 24 includes at least one interface for input. The interface for input is, for example, a physical key, a capacitive key, a pointing device, a touch screen integrally provided with a display, or a microphone. The input interface 24 accepts an operation for inputting data to be used in the operations of the information providing apparatus 20. The input interface 24 may be connected to the information providing apparatus 20 as an external input device, instead of being provided to the information providing apparatus 20. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the information providing apparatus 20. The output interface 25 may be connected to the information providing apparatus 20 as an external output device, instead of being provided to the information providing apparatus 20. As the connection method, any technology such as USB, HDMI®, or Bluetooth® can be used.

The functions of the information providing apparatus 20 are realized by execution of an information providing program according to the present embodiment by a processor serving as the controller 21. That is, the functions of the information providing apparatus 20 are realized by software. The information providing program causes a computer to execute the operations of the information providing apparatus 20, to thereby cause the computer to function as the information providing apparatus 20. That is, the computer functions as the information providing apparatus 20 by executing the operations of the information providing apparatus 20 in accordance with the information providing program.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may also be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. Each time a program is transferred from the server to the computer, the computer may sequentially execute processes in accordance with the received program. The processes may be executed through a so-called application service provider (ASP) type service which realizes functions merely by execution of instructions and acquisition of results, without transferring the program from a server to the computer. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the information providing apparatus 20 may be realized by a programmable circuit or a dedicated circuit as the controller 21. That is, some or all of the functions of the information providing apparatus 20 may be realized by hardware.

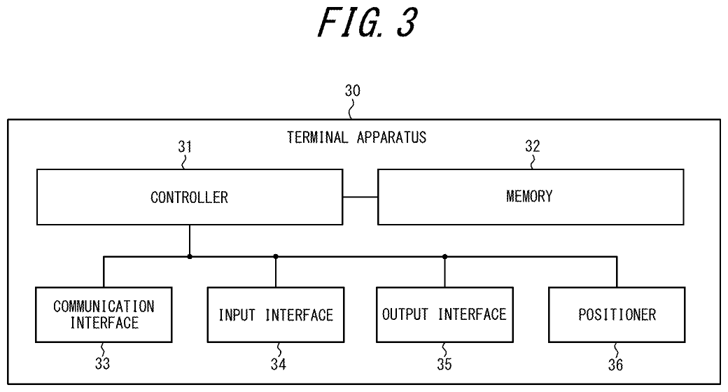

With reference to FIG. 3, a configuration of the terminal apparatus 30 according to the present embodiment will be described.

The terminal apparatus 30 includes a controller 31, a memory 32, a communication interface 33, an input interface 34, an output interface 35, and a positioner 36.

The controller 31 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to the operations of the terminal apparatus 30 while controlling components of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data to be used for the operations of the terminal apparatus 30 and data obtained by the operations of the terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives data to be used for the operations of the terminal apparatus 30, and transmits data obtained by the operations of the terminal apparatus 30.

The input interface 34 includes at least one interface for input. The interface for input is, for example, a physical key, a capacitive key, a pointing device, a touch screen integrally provided with a display, or a microphone. The input interface 34 accepts an operation for inputting data to be used for the operations of the terminal apparatus 30. The input interface 34 may be connected to the terminal apparatus 30 as an external input device, instead of being provided to the terminal apparatus 30. As the connection method, any technology such as USB, HDMI®, or Bluetooth® can be used.

The output interface 35 includes at least one interface for output. The interface for output is, for example, a display or a speaker. The display is, for example, an LCD or an organic EL display. The output interface 35 outputs data obtained by the operations of the terminal apparatus 30. The output interface 35 may be connected to the terminal apparatus 30 as an external output device, instead of being provided to the terminal apparatus 30. As the connection method, any technology such as USB, HDMI®, or Bluetooth® can be used.

The positioner 36 includes at least one GNSS receiver. The term “GNSS” is an abbreviation of global navigation satellite system. GNSS is, for example, GPS, QZSS, BeiDou, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 36 measures the position of the terminal apparatus 30.

The functions of the terminal apparatus 30 are realized by execution of an arbitrary terminal program by a processor serving as the controller 31. That is, the functions of the terminal apparatus 30 are realized by software. The terminal program causes a computer to execute the operations of the terminal apparatus 30, to thereby cause the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a programmable circuit or a dedicated circuit as the controller 31. That is, some or all of the functions of the terminal apparatus 30 may be realized by hardware.

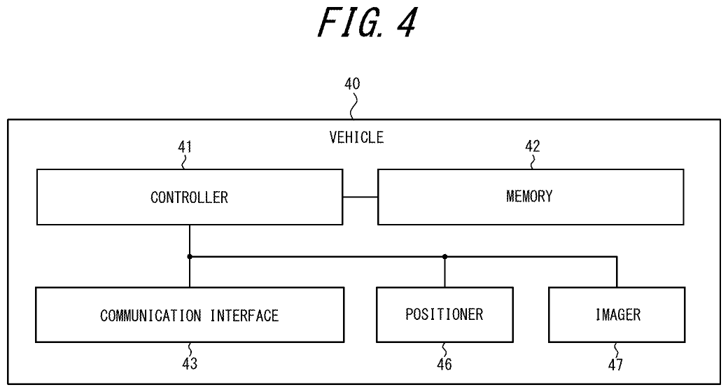

With reference to FIG. 4, a configuration of the vehicle 40 according to the present embodiment will be described.

The vehicle 40 includes a controller 41, a memory 42, a communication interface 43, a positioner 46, and an imager 47.

The controller 41 includes at least one processor, at least one programmable circuit, at least one dedicated circuit, at least one ECU, or a combination thereof. The term “ECU” is an abbreviation of electronic control unit. The processor is a general purpose processor such as a CPU or a GPU, or a dedicated processor that is dedicated to specific processing. The programmable circuit is, for example, an FPGA. The dedicated circuit is, for example, an ASIC. The controller 41 executes processing related to the operation of the vehicle 40 while controlling each functional component of the vehicle 40.

The memory 42 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores data to be used for the operations of the vehicle 40, and data obtained by the operations of the vehicle 40.

The communication interface 43 includes at least one interface for communication. The interface for communication is, for example, a LAN interface. The communication interface 43 receives data to be used for the operations of the vehicle 40 and also transmits data obtained by the operations of the vehicle 40.

The positioner 46 includes at least one GNSS receiver. GNSS is, for example, GPS, QZSS, BeiDou, GLONASS, or Galileo. The positioner 46 measures the position of the vehicle 40.

The imager 47 includes an in-vehicle camera for generating a moving image obtained by imaging a subject in the field of view. The moving image includes a plurality of still images captured at a predetermined frame rate, for example, 30 fps. Hereinafter, each of the plurality of still images is also referred to as a frame. The in-vehicle camera may be a monocular camera or a stereo camera. For example, an electronic device having a camera function, such as a driving recorder or a smartphone used by an occupant, may function as the imager 47.

The functions of the vehicle 40 are realized by execution of an arbitrary vehicle program by a processor serving as the controller 41. That is, the functions of the vehicle 40 are realized by software. The vehicle program causes the computer to execute the operations of the vehicle 40, to thereby cause the computer to function as the vehicle 40. That is, the computer functions as the vehicle 40 by performing the operations of the vehicle 40 according to the vehicle program.

Some or all of the functions of the vehicle 40 may be realized by a programmable circuit or a dedicated circuit as the controller 41. That is, some or all of the functions of the vehicle 40 may be realized by hardware.

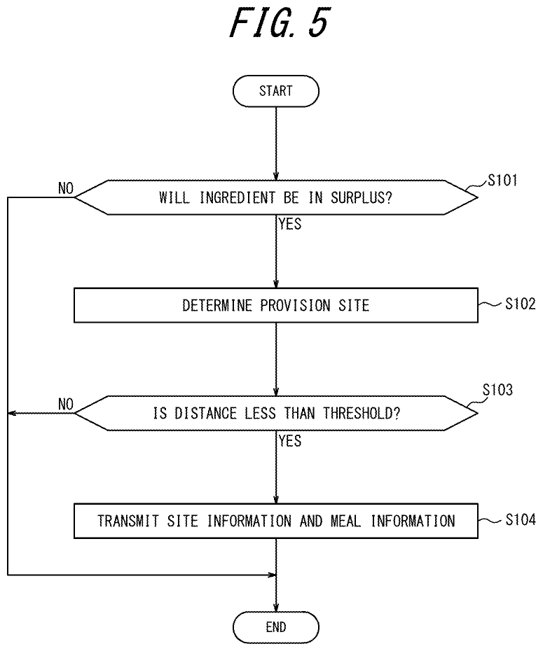

With reference to FIG. 5, operations of the information providing system 10 according to the present embodiment will be described. These operations correspond to the information providing method according to the present embodiment.

In Step S101, the controller 21 of the information providing apparatus 20 estimates whether an ingredient of a first meal to be cooked with the ingredient in the vehicle 40 will be in surplus, in which the first meal was scheduled to be provided to the first user but will not be provided to the first user. Any method may be used for estimating whether the ingredient will be in surplus. As one example, the controller 21 of the information providing apparatus 20 estimates whether the ingredient will be in surplus based on first site information indicating a first site at which the first meal is scheduled to be provided to the first user, first positional information indicating a position of the first user, and time information indicating a time at which the first meal is scheduled to be provided to the first user.

In the present embodiment, the vehicle 40 is stationary while an ingredient is being cooked. The controller 21 of the information providing apparatus 20 acquires, as the first site information, information indicating a site at which the vehicle 40 is located, in a case in which the first meal is scheduled to be provided to the first user at a dining space provided to the vehicle 40. In the present embodiment, a reservation database storing reservation information for the first user is constructed in the memory 42 of the vehicle 40. The reservation information for the first user stored in the reservation database is information indicating a type of a meal reserved by the first user, a place to provide the meal, a provision form in which the meal is to be provided, and a time at which the meal is scheduled to be provided. The controller 21 refers to the reservation database to determine, as the provision form in which the first meal is to be provided, that the first user has desired to have the meal at a dining space provided to the vehicle 40, and acquires, as first site information, information indicating a site at which the vehicle 40 is located. In a case in which it is determined, as the provision form in which the first meal is to be provided, that the first user has desired to take away the first meal from the vehicle 40, the controller 21 also acquires, as the first site information, information indicating a site at which the vehicle 40 is located.

The information indicating the site at which the vehicle 40 is located is, for example, positional information for the vehicle 40. The positional information for the vehicle 40 may be acquired by any method. As one example, the controller 21 of the information providing apparatus 20 acquires positional information indicating a position measured by the positioner 46 of the vehicle 40 as the positional information for the vehicle 40. The position is indicated by, for example, two-dimensional coordinates or three-dimensional coordinates.

As a variation of the present embodiment, the controller 21 of the information providing apparatus 20 acquires, in Step S101, information indicating a site that is designated by the first user as the first site information, in a case in which the first meal is scheduled to be delivered to the first user by the vehicle 40. The controller 21 refers to the reservation database constructed in the memory 42 of the vehicle 40 to determine, as the provision form in which the first meal is to be provided, that the first user has desired to have the first meal delivered, and acquires, as the first site information, information indicating a site that has been designated by the first user and included in the reservation information. The site that has been designated by the first user is, for example, a site at which the first user has desired to receive the first meal to be delivered.

The first positional information may be acquired by any method. As one example, the controller 21 of the information providing apparatus 20 acquires, as the first positional information, positional information indicating a position measured by a positioner of a terminal apparatus possessed by the first user.

The time information indicating a time at which the first meal is scheduled to be provided to the first user is information indicating the start time of a time slot reserved by the first user among the reserved time slots in the vehicle 40. The time information may be acquired by any method. In the present embodiment, the controller 21 of the information providing apparatus 20 refers to a database constructed in the memory 42 of the vehicle 40 that stores the reservation status of the vehicle 40, to acquire the time information.

The controller 21 of the information providing apparatus 20 calculates time required to travel from the position indicated by the first positional information to the site indicated by the first site information. The controller 21 may independently calculate the time required, or may use an external system such as an Internet-based GIS to calculate the time required. The term “GIS” is an abbreviation of geographic information system. The controller 21 predicts whether the first user can make it to the time indicated by the time information. Specifically, the controller 21 predicts an arrival time at which the first user is to arrive at the vehicle 40, based on the calculated required time. When the predicted arrival time is later than the start time of the time slot reserved by the first user, the controller 21 predicts that the first user cannot make it to the time.

The controller 21 of the information providing apparatus 20 estimates that the ingredient will be in surplus, in a case in which it is predicted that the first user cannot make it to the time. This is because in a case in which the first user cannot make it to the time, the reservation is highly likely to be cancelled or changed and the first meal that was scheduled to be provided to the first user will no longer be needed and therefore the ingredient will be in surplus.

In a case in which the first user cannot make it to the time, that is, in a case in which it is estimated that the ingredient will be in surplus, the process of Step S102 is performed. In a case in which the first user can make it to the time, that is, in a case in which it is estimated that the ingredient will not be in surplus, the flow of FIG. 5 ends.

In Step S102, the controller 21 of the information providing apparatus 20 determines a second site at which to provide, to the second user 12, a second meal obtained by cooking the ingredient in the vehicle 40. The second meal is a meal obtained by cooking, in the vehicle 40, the ingredient estimated to be in surplus in Step S101. The type of the second meal may be the same or different from the type of the first meal, as long as the ingredient to be cooked is the same. As a practical example, suppose that the meal that was scheduled to be provided to the first user is a hamburger steak and the ingredient estimated to be in surplus is ground meat. In this case, the meal to be provided to the second user 12 may be a hamburger steak or may be a keema curry.

The second site at which to provide the second meal to the second user 12 may be determined by any method. In the present embodiment, the second meal is to be provided at the vehicle 40. Accordingly, the controller 21 of the information providing apparatus 20 determines the site at which the vehicle 40 is located to be the second site.

As a variation of the present embodiment, in a case in which the second meal is to be delivered to the second user 12, the controller 21 of the information providing apparatus 20 determines a site at which the distance from the position of the vehicle 40 is less than a second threshold V2 to be the second site. That is, a site away from the vehicle 40 is determined as the second site. The second threshold V2 may be any value and may be, for example, a distance that can be traveled by the vehicle 40 within a time it takes to cook the second meal. In this variation, the vehicle 40 is traveling while the ingredient is being cooked. The vehicle 40 can travel to the second site while the ingredient is being cooked. Accordingly, the second meal may be arranged to be ready when the vehicle 40 arrives at the second site, so that the waiting time for the second user 12 to receive the second meal is reduced and the second meal can be freshly prepared and provided to the second user 12, as compared with a case in which the second meal is delivered after it is cooked. For example, suppose that it takes 30 minutes to cook the second meal. Suppose that the vehicle 40 is traveling at a speed of 40 km/h. This makes the second threshold V2 to be 20 km. The second meal delivered to the second site may be provided to the second user 12 as a takeaway, or may be provided at a dining space of the vehicle 40.

The controller 21 of the information providing apparatus 20 generates second meal information indicating details of the second meal, in a case in which the second site has been determined. The controller 21 generates, as the second meal information, information indicating the name, quantity, or price of the second meal. The controller 21 may generate, as the second meal information, information indicating a time at which to provide the second meal. The time at which to provide the second meal may be determined by any method. As one example, the controller 21 determines, as the time at which to provide the second meal, a time by which the cooking of the ingredient is completed to have the second meal ready.

In Step S103, the controller 21 of the information providing apparatus 20 acquires second positional information indicating the position of the second user 12, and determines whether the distance from the position indicated by the acquired second positional information to the second site indicated by the second site information is less than a first threshold V1. The second positional information may be acquired by any method. As one example, the controller 21 of the information providing apparatus 20 acquires, as the second positional information, positional information indicating a position measured by the positioner 36 of the terminal apparatus 30 possessed by the second user 12.

In the present embodiment, the second site is a position of the vehicle 40. The first threshold V1 may be any value, but when the first threshold V1 is too large, it may take time for the second user 12 to arrive at the vehicle 40 and the quality of the second dish can deteriorate, such as when the finished second meal gets cold. Therefore, in the present embodiment, the first threshold V1 is adjusted to a value that can ensure the quality of the second meal. Specifically, the first threshold V1 is set to a distance that can be traveled by the second user 12 within a time it takes to cook the second meal. That is, the first threshold V1 is set to a distance that enables the second user 12 to arrive at the vehicle 40 no later than the second meal is completed. For example, suppose that it takes 30 minutes to cook the second meal. Suppose that the traveling speed of the second user 12 is 4 km/h. This makes the first threshold V1 to be 2 km. In the present embodiment, in a case in which the distance from the position of the first user to the first site is less than 2 km, the process of Step S104 is performed. In a case in which the distance from the position of the first user to the first site is 2 km or more, the flow of FIG. 5 ends.

In Step S104, the communication interface 23 of the information providing apparatus 20 transmits the second meal information generated by the controller 21 in Step S102 to the terminal apparatus 30 of the second user 12 together with the second site information indicating the second site.

The communication interface 33 of the terminal apparatus 30 receives the second site information and the second meal information transmitted in Step S104, from the information providing apparatus 20. The controller 31 of the terminal apparatus 30 acquires the second site information and the second meal information received by the communication interface 33.

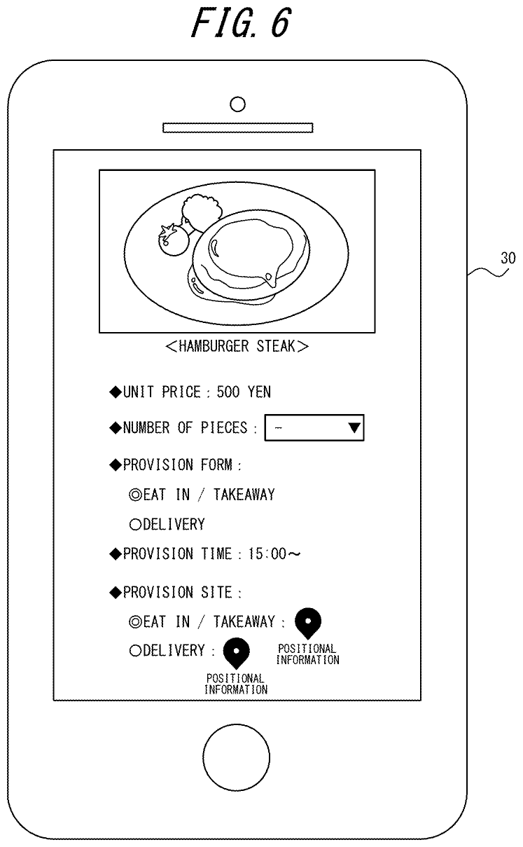

The controller 31 of the terminal apparatus 30 presents the acquired second site information and the second meal information to the second user 12. Specifically, the controller 31 of the terminal apparatus 30 causes the output interface 35 to output the position of the vehicle 40 indicated by the second site information and the name, quantity, or price of the second meal indicated by the second meal information. In the present embodiment, the controller 31 displays the second site information and the second meal information on a display corresponding to the output interface 35 as illustrated in FIG. 6, but may output by voice from a speaker corresponding to the output interface 35. In FIG. 6, “HAMBURGER STEAK”, “NUMBER OF PIECES”, and “500 YEN” are each displayed as the name, quantity, and price, respectively, of the second meal indicated by the second meal information. The “NUMBER OF PIECES” as the quantity is selected and displayed in a pull-down menu with the maximum number of pieces that can be provided. In a case in which the number of pieces has not been selected, “-” is displayed. In addition, the “PROVISION SITE” is displayed as the second site information. In this example, the second meal is to be provided in the provision form of being provided at the vehicle 40. That is, “EAT IN/TAKEAWAY” has been selected. When the location icon to the right of “EAT IN/TAKEAWAY” is tapped as the provision site by the second user 12, a map is displayed and the location of the site where the vehicle 40 is located is indicated as the second site. Alternatively, in a case in which the second meal is to be provided in the form of being delivered by the vehicle 40, “DELIVERY” is selected as the provision form in which the second meal is to be provided. In this case, when the location icon to the right of “DELIVERY” is tapped as the provision site by the second user 12, a map is displayed and the location of a site at which the distance from the vehicle 40 is less than the second threshold V2 is indicated as the second site.

The present embodiment enables to provide an ingredient that is in surplus without having been provided to a first user, to a second user 12 as a second meal. As a result, an ingredient in surplus can be effectively used without going waste.

In the present embodiment, in a case in which the first meal or the second meal is provided at the vehicle 40 as a takeaway, the vehicle 40 may not be provided with a dining space.

As a variation of the present embodiment, the information providing apparatus 20 may be mounted in the vehicle 40.

The present disclosure is not limited to the embodiment described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order in accordance with the processing capability of the apparatus that executes each step, or as required. Other modifications can be made without departing from the spirit of the present disclosure.

1. An information providing apparatus comprising a controller configured to:
estimate whether an ingredient of a first meal to be cooked with the ingredient in a vehicle will be in surplus, wherein the first meal was scheduled to be provided to a first user but will not be provided to the first user; and
in a case in which it is estimated that the ingredient will be in surplus, determine a site at which to provide a second meal to be cooked with the ingredient in the vehicle, to a second user different from the first user.

2. The information providing apparatus according to claim 1, wherein the controller is configured to estimate whether the ingredient will be in surplus based on first site information indicating a site at which the first meal is scheduled to be provided to the first user, first positional information indicating a position of the first user, and time information indicating a time at which the first meal is scheduled to be provided to the first user.

3. The information providing apparatus according to claim 2, wherein the controller is configured to:
calculate a time required to travel from the position indicated by the first positional information to the site indicated by the first site information to predict whether the first user can make it to the time indicated by the time information; and
estimate that the ingredient will be in surplus in a case in which it is predicted that the first user cannot make it to the time.

4. The information providing apparatus according to claim 2, wherein the controller is configured to acquire, as the first site information, information indicating a site at which the vehicle is located, in a case in which the first meal is scheduled to be provided to the first user at a dining space provided to the vehicle.

5. The information providing apparatus according to claim 2, wherein the controller is configured to acquire, as the first site information, information indicating a site that is designated by the first user, in a case in which the first meal is scheduled to be delivered to the first user by the vehicle.

6. The information providing apparatus according to claim 1, further comprising a communication interface configured to transmit, in a case in which a site at which to provide the second meal to the second user is determined by the controller, second meal information indicating details of the second meal to a terminal apparatus of the second user together with second site information indicating the determined site.

7. The information providing apparatus according to claim 6, wherein the controller is configured to generate, as the second meal information, information indicating a name, quantity, or price of the second meal.

8. The information providing apparatus according to claim 6, wherein the controller is configured to generate, as the second meal information, information indicating a time to provide the second meal.

9. The information providing apparatus according to claim 6, wherein the controller is configured to:
acquire second positional information indicating a position of the second user; and
transmit the second positional information and the second meal information in a case in which a distance from the position indicated by the acquired second positional information to the second site indicated by the second site information is less than a first threshold.

10. The information providing apparatus according to claim 1, wherein the controller is configured to determine, in a case in which it is determined that the ingredient will be in surplus, a site at which the vehicle is located to be the site at which to provide the second meal to the second user.

11. The information providing apparatus according to claim 1, wherein the controller is configured to determine, in a case in which it is determined that the ingredient will be in surplus, a site at which a distance from the position of the vehicle is less than a second threshold to be the site at which to provide the second meal to the second user.

12. A vehicle having the information providing apparatus according to claim 1 mounted therein.

13. An information providing system comprising:
the information providing apparatus according to claim 1; and
a terminal apparatus configured to communicate with the information providing apparatus.

14. A non-transitory computer readable medium storing an information providing program configured to cause a computer to execute operations, the operations comprising:
estimating whether an ingredient of a first meal to be cooked with the ingredient in a vehicle will be in surplus, wherein the first meal was scheduled to be provided to a first user but will not be provided to the first user; and
in a case in which it is estimated that the ingredient will be in surplus, determining a site at which to provide a second meal to be cooked with the ingredient in the vehicle, to a second user different from the first user.

15. The non-transitory computer readable medium according to claim 14, wherein the estimating comprises estimating whether the ingredient will be in surplus based on first site information indicating a site at which the first meal is scheduled to be provided to the first user, first positional information indicating a position of the first user, and time information indicating a time at which the first meal is scheduled to be provided to the first user.

16. The non-transitory computer readable medium according to claim 15, wherein the estimating comprises:
calculating a time required to travel from the position indicated by the first positional information to the site indicated by the first site information to predict whether the first user can make it to the time indicated by the time information; and
estimating that the ingredient will be in surplus in a case in which it is predicted that the first user cannot make it to the time.

17. An information providing method, comprising:
estimating, by an information providing apparatus, whether an ingredient of a first meal to be cooked with the ingredient in a vehicle will be in surplus, wherein the first meal was scheduled to be provided to a first user but will not be provided to the first user; and
in a case in which it is estimated that the ingredient will be in surplus, determining, by the information providing apparatus, a site at which to provide a second meal to be cooked with the ingredient in the vehicle, to a second user different from the first user.

18. The information providing method according to claim 17, wherein the estimating comprises estimating whether the ingredient will be in surplus based on first site information indicating a site at which the first meal is scheduled to be provided to the first user, first positional information indicating a position of the first user, and time information indicating a time at which the first meal is scheduled to be provided to the first user.

19. The information providing method for providing information according to claim 18, wherein the estimating comprises:
calculating a time required to travel from the position indicated by the first positional information to the site indicated by the first site information to predict whether the first user can make it to the time indicated by the time information; and
estimating that the ingredient will be in surplus in a case in which it is predicted that the first user cannot make it to the time.

20. The information providing method according to claim 17, further comprising transmitting, in a case in which a site at which to provide the second meal to the second user is determined by the information providing apparatus, second meal information indicating details of the second meal to a terminal apparatus of the second user together with second site information indicating the determined site.
